(19) United States
(12) Patent Application Publication
(10) Pub. No.: US 2012/0301130 A1
(43) Pub. Date: Nov. 29, 2012

(54) Magnetic array control system for angular orientation of an instrument

(76) Inventor: Fleming Shi, Cupertino, CA (US)

(21) Appl. No.: 13/115,278

(22) Filed: May 25, 2011

(51) Int. Cl. G03B 17/00; H01F 7/20

(52) U.S. Cl. 396/428; 335/289

(57) ABSTRACT

A system includes an instrument coupled to a magnetic material. The orientation of the instrument is influenced by a magnetic field generated by an array of magnetic elements. Each element of the array is controlled by a data value in a magnetic control store to produce a field strength and polarity. Overwriting the pattern in the magnetic control store will result in a magnetic field which applies a torque to the instrument and cause an azimuthal or elevational rotary movement about the center of the instrument.

### RELATED APPLICATIONS

None

### BACKGROUND

It is known that magnetic fields may be controlled by applying an electrical current in one or other direction and varying the amount of current. As solid state cameras continue to be reduced in size, it is desirable to also reduce the size, complexity, and number of parts required to control the orientation of a camera in azimuth and elevation.

### BRIEF DESCRIPTION OF FIGURES

The appended claims set forth the features of the invention with particularity. The invention, together with its advantages, may be best understood from the following detailed description taken in conjunction with the accompanying drawings of which:

FIG. 1 is one substantially triangular array of controllable magnet elements;

FIG. 2 is an assembly composed of a plurality of arrays which may be approximately a curved surface;

FIG. 3 is a map of 15 addressable sectors in a programmable magnet control memory;

FIG. 4 is an illustration of a plurality of assemblies configured to approximate two hemispheres, each facet being a triangular array of controllable magnet elements;

FIG. 5 illustrates a movable “virtual” horseshoe or C shaped magnet configured at the exterior of a hemisphere which controls the field location and strength within the hemisphere;

FIG. 6 illustrates a plurality of movable “virtual” horseshoe or C shaped magnets configured at the exterior of a hemisphere which controls the field location and strength within the hemisphere; and

FIG. 7 illustrates a camera enclosed by a housing.

### SUMMARY OF THE INVENTION

An instrument, such as a camera, is oriented by applying a magnetic image to permanent magnets rigidly coupled to the instrument. The magnetic image is generated by a computer controlled array of electro-magnetic elements which combine to generate a complex magnetic field. The magnetic image “moves” across the array whereby angular forces change the orientation of the instrument. A substantially spherical camera body couples the instrument to the permanent magnets and to a bearing which enables angular movement in two dimensions. One aspect of the invention is a magnetic memory control system which sets polarity and strength of each element of an array of magnets.

### DETAILED DISCLOSURE OF EMBODIMENTS OF THE INVENTION

One aspect of the invention is an array of controllable magnetic elements communicatively coupled to a magnetic control store. In an embodiment, the array is curved in two dimensions forming a substantially spherical cavity. An orientation control circuit writes a data pattern into the magnetic control store which represents magnetic strength and polarity for each location in the array. The array combines these individual element strengths and polarities to generate a field within the cavity which applies a magnetic force on magnetic materials.

An instrument, in an embodiment, a camera substantially within the cavity has magnetic materials rigidly attached such as permanent magnets, or magnetic materials such as iron or nickel sufficiently close to the magnetic array to receive a magnetic force. When the data pattern in the magnetic control store changes, a force is exerted by the aggregate field induced by the array of elements causing the instrument to reorient in azimuth or in elevation or in both. It is understood that inclination and elevation are translatable terms requiring only a simple mathematical transformation.

Referring now to FIG. 1, a substantially triangular array of controllable magnet elements 100, is composed of a plurality of three or more elements 111, 112, 113 which can be set in polarity to be North or South or unpolarized and magnetic strength. In an embodiment as shown 15 controllable magnet elements are arranged in an approximate triangle. One embodiment arranges the magnet elements in an isosceles triangle.

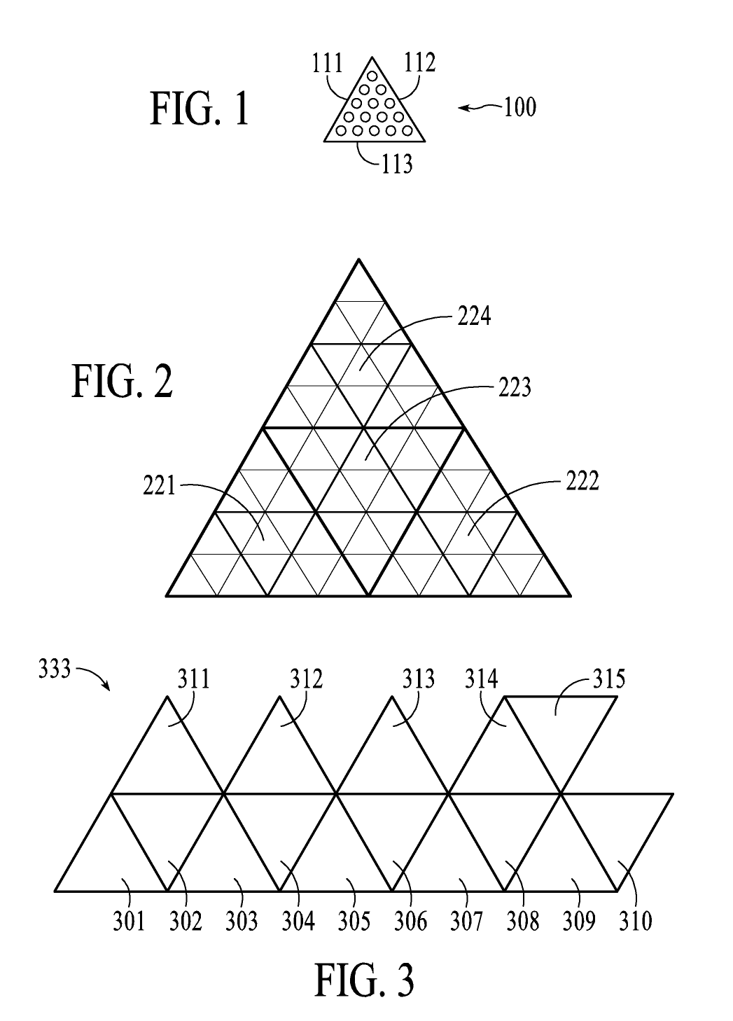

Referring now to FIG. 2, an assembly is made by coupling a plurality of arrays 221, 222, 223, 224 which may approximate a curved surface. In an embodiment, each corner of each triangle is aligned on a great circle of a sphere. In an embodiment, a hierarchy of triangles is made of component triangles but which are attached to adjacent triangles at an angle such that no triangle is in the same plane as its adjacent triangles.

Referring now to FIG. 3, in an embodiment, a map of addressable sectors 301-315 make up a programmable magnet control memory 333. Fifteen sectors are shown but only to illustrate one embodiment easily drawn. Each controllable magnet element has a corresponding address in a magnet control memory store. Data values stored in each addressable location in memory store control the strength and polarity of one magnetic element in the array. When a plurality of adjacent magnetic elements are set to the same polarity, the effect is that of a magnet positioned between or among the locations of the magnetic elements. The effect of a moving magnetic pole is accomplished by writing over the memory store with a plurality of images of slightly different strength. Memory sectors 311 and 312 control adjacent arrays of magnetic elements so a magnetic pole may be positioned on the join of two triangles by setting an equal strength in both arrays on elements along the edge.

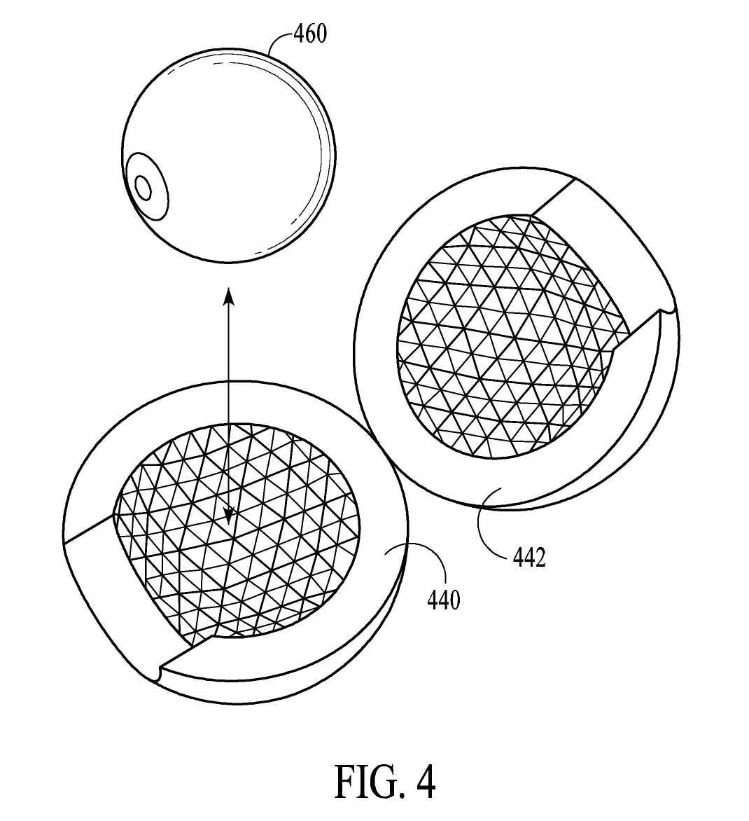

Referring now to FIG. 4 an illustration shows two hemispheres 440 442. In an embodiment the hemispheres may be coupled to enclose a single camera 460. A non-dimensional, exemplary embodiment is shown having each facet being a triangular array of controllable magnet elements.

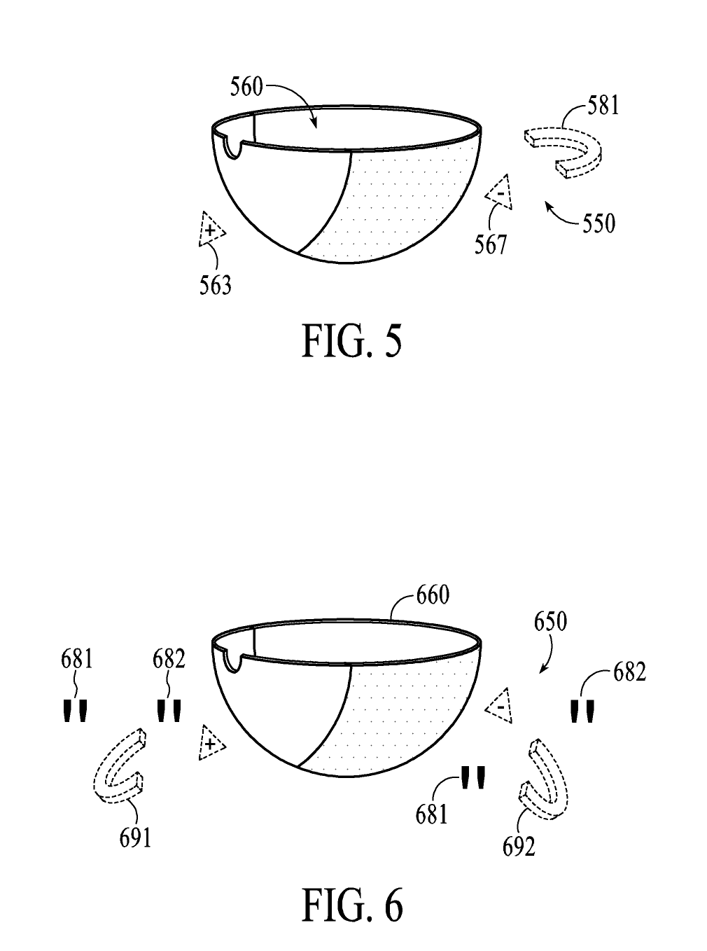

Referring to FIG. 5 a movable “virtual” horseshoe or C shaped magnet 581 is disposed at the exterior of a hemisphere 550. Such a “virtual” magnet controls the field location and strength within the hemisphere. The field effect of such a virtual magnet is approximated by setting and switching some of the controllable magnetic elements that make up the hemisphere. Up to this point we have assumed for simplicity a single north pole 563 and a single south pole 567 fixedly coupled to the instrument or camera 560. But a magnet is not required if there are simply magnetic materials that will be drawn toward the fields generated by the array.

Hence, referring to FIG. 6 a plurality of movable “virtual” horseshoe or C shaped magnets 691 692 is illustrated at the exterior of a hemisphere 650 which controls the field location and strength within the hemisphere. If there are more than one magnetic “tractor” points 681 682 coupled to the instrument 660, the movement and position of the virtual magnets will orient the instrument. In other words the equivalent of a piece of iron or nickel attached to the instrument will enable orientation control by setting values in the memory store.

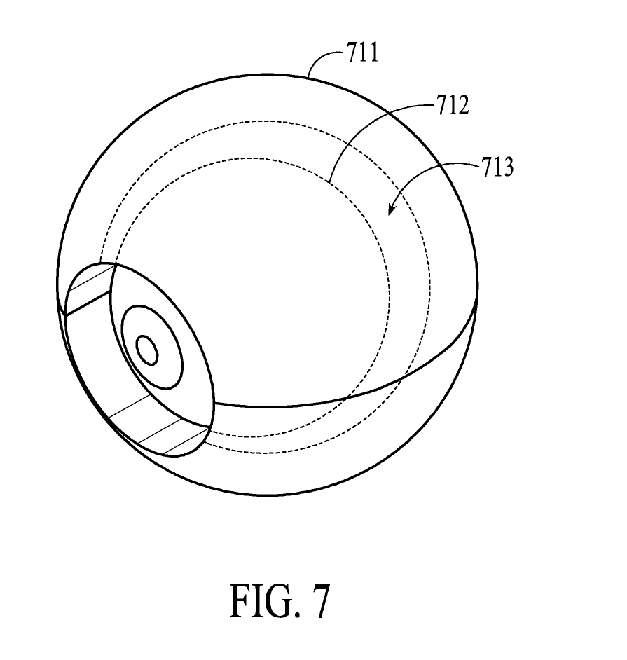

Referring now to FIG. 7, when a camera is enclosed by the housing 711, the surfaces between the camera eye 712 and the housing wall should have a gap 713 allowing the camera to rotate or revolve ie. “look” in any direction freely.

A directional instrument, such as an antenna, camera, or projector is rigidly coupled to a plurality of magnets, in an embodiment permanent magnets arranged in a non-symmetrical pattern. Application of a complex magnetic field which we in this application define to be a magnetic image, causes an angular force to align the instrument in at least two angular dimensions. The instrument may be oriented in azimuth or elevation or both. In an embodiment, the third angular dimension is also controlled. A magnetic image generator comprises a computer controlled array of electro-magnetic elements, each of which can be individually controlled in polarity and strength. A magnetic image is shifted across the computer controlled array by gradually changing the polarity and strength of individual elements just as motion is visually projected by an array of light emitting diodes.

In an embodiment the instrument is a camera enclosed in a substantially spherical camera body. In an embodiment, permanent magnets are embedded in the surface of the camera body. In an embodiment the array of electro-magnetic elements is configured in a three dimensionally curved concave surface offset from the magnets coupled to the instrument.

The instrument is further coupled to a universal bearing. The bearing may be gimbals to allow angular translation in at least elevation and azimuth. The bearing may be a fluid such as air, mercury, water, or oil. The instrument may float in the fluid based on displacement or the fluid may be flowing under pressure to support the weight of the instrument. The bearing may be magnetic levitation and provide part or all of the magnetic image which aligns the instrument.

In one embodiment the instrument has attraction points which are drawn toward any magnetic field. For example, one or more iron fixtures fixedly coupled to the instrument would be pulled toward magnetic elements of the array which have been energized. In an other embodiment, the instrument has both attraction and repellant points which receive magnetic forces from both a north pole and a south pole induced in the array by the polarity and strength of the elements controlled by the control memory according to the following means.

### Means, Embodiments, and Structures

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated.

Any of the operations described herein that form part of the invention are useful machine operations. The invention also related to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a non-transitory computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network-coupled computer system so that the computer readable code is stored and executed in a distributed fashion. Within this application, references to a computer readable medium mean any of well-known non-transitory tangible media.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

### Conclusion

The invention can be easily distinguished from solutions that utilize gears and motors to orient instruments in two or more axes. Conventional orientation solutions require a motor to apply force in latitudinal direction and another motor to apply force in a longitudinal direction.

What is claimed is:

1. A camera enclosed in substantially spherical camera body, said camera body having permanent magnets embedded in a non-symmetrical pattern, said camera body magnetically coupled to an array of electro-magnetic elements which produces a complex magnetic image whereby the camera receives an angular force to align the camera in at least two dimensions.

2. A substantially spherical camera body coupled to a magnetic bearing which allows translation in at least two angular dimensions and applies an angular force through an array of individually controllable electromagnetic elements.

3. An array of individually controllable electromagnetic elements presents a magnetic image to continuously reorient in two angular dimensions an instrument rigidly coupled to a plurality of magnets.

4. A method for controlling the orientation of a instrument comprising:
determining a desired angular orientation of said instrument;
translating the desired angular orientation to a magnetic image; and
generating said magnetic image on an array of individually controllable electro-magnetic elements.

5. An apparatus for magnetic controlling the orientation of a directional instrument wherein said instrument is rigidly coupled to a plurality of magnets:
an array of individually controllable electromagnetic elements,
said array electrically coupled to a computer readable memory,
said computer readable memory coupled to a processor enabled to store into the computer readable memory a two dimensional pattern, whereby the two dimensional pattern determines polarity and strength of each element of the array.
